(19) United States
(12) Patent Application Publication
(10) Pub. No.: US 2016/0329594 A1
(43) Pub. Date: Nov. 10, 2016

(54) SOLID STATE BATTERY

(71) Applicant: FORD GLOBAL TECHNOLOGIES, LLC, Dearborn, MI (US)

(72) Inventors: Andrew Robert Drews, Ann Arbor, MI (US); Venkataramani Anandan, Farmington Hills, MI (US)

(21) Appl. No.: 14/706,122

(22) Filed: May 7, 2015

(51) Int. Cl. H01M 10/04; H01M 10/052; H01M 4/66; H01M 10/654

(52) U.S. Cl. CPC H01M 10/04; H01M 10/654; H01M 10/052; H01M 4/661

(57) ABSTRACT

A solid state battery including an extruded, interconnected network of a first electrochemically active material forming a plurality of channels; an electrolyte coated onto surfaces of each of the plurality of channels and forming a plurality of coated channels; and a second electrochemically active material situated within each coated channel.

### TECHNICAL FIELD

The present disclosure is related to a solid state battery and process to make the same.

### BACKGROUND

Solid state batteries include solid electrodes and a solid electrolyte material. The solid state batteries may include ceramic electrolyte material. Solid electrolytes are an alternative to flammable and unstable liquid battery electrolytes. Based on this promise, a considerable amount of development has been performed to develop such solid state batteries. But the current types of proposed solid state batteries suffer from a lack of manufacturability due to their relative brittleness and susceptibility to fracture. In addition, current manufacturing methods are not suitable for large-format, high-energy batteries needed for transportation or stationary grid-support applications. Scalable manufacturing methods to provide thin electrolytes are needed to provide enhanced energy and power density. These methods necessarily require solid electrolytes that are thin. However, the relative brittleness of thin sheet forms of solid electrolyte materials contributes to susceptibility to fracture.

### SUMMARY

According to one embodiment, a solid state battery is disclosed. The solid state battery may include an extruded, interconnected network of a first electrochemically active material forming a plurality of channels, an electrolyte coated onto surfaces of each of the plurality of channels and forming a plurality of coated channels, and a second electrochemically active material situated within each coated channel. The first electrochemically active material may be one of a cathode or anode and the second electrochemically active material may be the other of a cathode or anode. The electrolyte may separate the extruded, interconnected network from the second electrochemically active material. The thickness of the electrolyte in at least one of the coated channels may be in a range of about 50 nm to about 100 μm (t_{E}). The electrolyte may be a solid electrolyte. The electrolyte may be coated onto surfaces of the channels as a conformal coating. The second electrochemically active material may be electrically connected. Each coated channel may further include a plurality of solid electrolyte particles. The solid electrolyte particles and the second electrochemically active material may be mixed and sintered together to form a sintered mixture. The sintered mixture may include a plurality of pores including a conductive metal. The conductive metal may form a conformal coating. The plurality of pores including the conductive metal may be distributed throughout the sintered mixture. The conductive metal may be a current collector. The conductive material may run the length of the battery housing. The battery may be a lithium battery.

According to another embodiment, a solid state battery is disclosed. The solid state battery may include a battery housing, an extruded, interconnected network of non-porous, electrochemically conductive walls forming a solid electrolyte within the battery housing, a plurality of channels formed by the extruded, interconnected network, a cathode situated within a first number of the plurality of channels, and an anode situated within a second number of the plurality of channels. The cathode and anode may be separated by at least one of the non-porous, electrically conductive walls. The thickness of the non-porous, electrochemically conductive walls may be in the range of about 5 to about 2,500 μm (t_{w}). The cathode and anode may be separated by at least one insulating channel formed from at least one of the plurality of channels. The first number may be equal or not equal to the second number. The plurality of channels may include one or more heating or cooling channels. The extruded, interconnected network of non-porous, electrochemically conductive walls may run the length of the battery housing.

According to yet another embodiment, a solid state battery is disclosed. The solid state battery may include a battery housing, an extruded, interconnected network of non-porous, ionically conductive walls forming a solid electrolyte and a plurality of channels within the battery housing, an anode or cathode situated within the plurality of channels including a sintered mixture of solid electrolyte particles and an electrochemically active material, and a conductive metal situated in the plurality of pores. The sintered mixture may include a plurality of pores. The conductive metal may form a conformal coating. The plurality of pores may include the conductive metal, which may be distributed throughout the sintered mixture. The conductive metal may be a current collector. The conductive material may run the length of the battery housing. The battery may be a lithium battery.

Another embodiment discloses a solid state battery including a housing, an extruded, interconnected network of non-porous, electrochemically conductive walls forming a solid electrolyte within the housing, a plurality of channels formed by the extruded, interconnected network, and at least first and second series-connected electrochemically active materials situated within at least a first and second number of the plurality of channels. Each channel within the series may be separated by a wall of t₁, each series separated by a wall of t₂, and t₂>t₁·t₁ may be in a range of about 5 to about 2,500 μm. t₂ may be in a range of about 50 to about 25,000 μm. Each series may be separated by at least one insulating channel formed from at least one of the plurality of channels. Each series may be separated by at least one heating or cooling channel. The battery may be a lithium battery.

### BRIEF DESCRIPTION OF THE DRAWINGS

FIG. 1 depicts a perspective view of a solid state battery in accordance with one embodiment;

FIG. 2 depicts an enlarged fragmented view of region A of FIG. 1;

FIG. 3A depicts a perspective fragmented view of a plurality of channels within a solid state battery with an equal number of channels for each active material;

FIG. 3B depicts a perspective fragmented view of a plurality of channels within a solid state battery with an unequal number of channels for each active material;

FIG. 3C illustrates an enlarged fragmented view of region B of FIG. 1 having a ratio of channel volumes different than 1:1;

FIG. 4 illustrates a perspective view of a solid state battery having a plurality of insulating channels and a plurality of heating or cooling channels;

FIG. 5A shows a cross section view taken along line 5A-5A of FIG. 2 of a channel including electrochemically active material and a wire as a conductive element;

FIG. 5B illustrates a cross section view taken along line 5B-5B of FIG. 2 of a channel including a sintered mixture and a conformal layer of the conductive element in the pores;

FIG. 6 illustrates a schematic view of a plurality of channels connected in series within a single solid state battery monolith; and

FIG. 7 depicts a perspective view of an extruded active material monolith forming a plurality of channels lined with solid electrolyte and filled with the opposite active material.

### DETAILED DESCRIPTION

Reference will now be made in detail to compositions, embodiments, and methods of the present invention known to the inventors. However, it should be understood that disclosed embodiments are merely exemplary of the present invention which may be embodied in various and alternative forms. Therefore, specific details disclosed herein are not to be interpreted as limiting, rather merely as representative bases for teaching one skilled in the art to variously employ the present invention.

Except where expressly indicated, all numerical quantities in this description indicating amounts of material or conditions of reaction and/or use are to be understood as modified by the word “about” in describing the broadest scope of the present invention.

The description of a group or class of materials as suitable for a given purpose in connection with one or more embodiments of the present invention implies that mixtures of any two or more of the members of the group or class are suitable. Description of constituents in chemical terms refers to the constituents at the time of addition to any combination specified in the description, and does not necessarily preclude chemical interactions among constituents of the mixture once mixed. The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

Solid state batteries have both solid electrodes and solid electrolyte. The solid state battery cells are typically based on ceramic electrolytes which are a promising alternative to flammable and unstable liquid electrolytes for batteries. But the implementation of current solid electrolyte-based batteries is challenging due to the limited conductivity of solid electrolytes and several competing factors such as a need for a low cell resistance and good mechanical robustness.

To achieve high energy and power density, and to avoid high overpotential, sheets of solid electrolyte must be very thin, usually about 25 to about 100 μm. A typical lithium-ion battery includes a separator, which is typically a thin, flexible polymer sheet of about 25 μm thick, separating the opposing electrodes. Such a thin ceramic sheet is very susceptible to fracture and thus is not usually suitable in automotive applications because manufacturing of a large format battery using thin sheets of solid electrolyte as separators would be difficult and impractical. Yet, increasing the thickness of the separator to achieve the required strength may compromise the energy and power density of the battery.

Additionally, existing monolith battery designs have a number of further disadvantages. For example, some solid electrolyte batteries provide porous, non-conducting walls with liquid electrolytes. Additionally, some other solid electrolyte batteries use a wire current collector which may not provide ideal electronic conduction to or among the electrode particles within the chambers of the battery. The existing monolith batteries may also experience undesirable temperature changes. Finally, existing monolith battery designs do not allow for a series connection of cells within the battery monolith.

In light of the foregoing, there is a need for an alternative design of a solid state battery to provide low cell resistance as well as high energy and power densities in mechanically robust packaging that can be manufactured in high volume and with high reliability.

A solid electrolyte battery solving one or more of the above-mentioned disadvantages is presented herein. The monolithic body of the battery is divided into many individual channels, where the channels are separated by walls of solid electrolyte. By dividing the monolith into a lattice of channels, the unsupported portions of each wall are relatively small, resulting in a very strong monolithic structure. One exemplary method for producing the monolithic housing is extrusion. By subdividing the solid electrolyte to form the walls of channels filled with active materials, the extruded monolith minimizes the mass and volume of the solid electrolyte material while being sufficiently robust and having a relatively high efficiency of packing the active material.

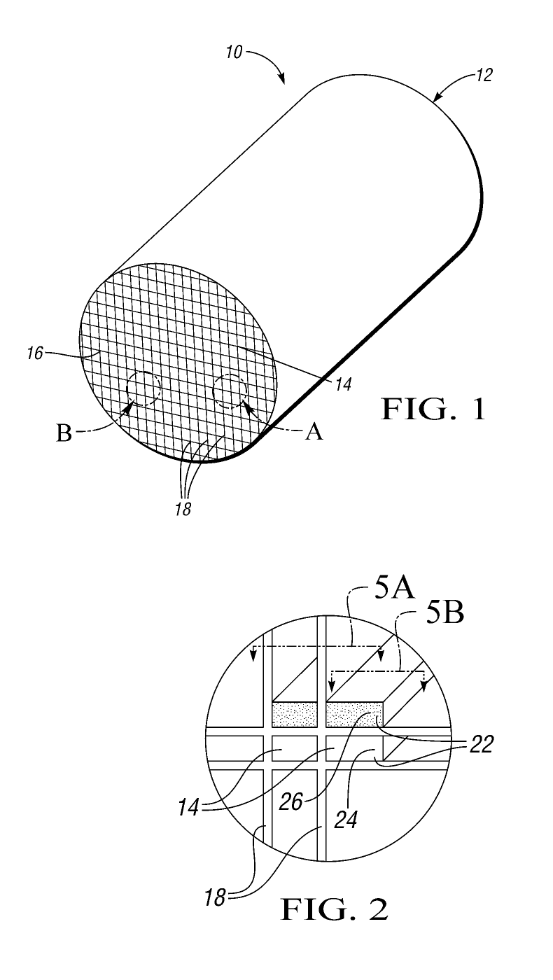

The solid state battery of the present disclosure may be produced by an extrusion process. As can be seen in a non-limiting example of a solid state battery 10 of FIG. 1, an extruded monolithic housing of solid electrolyte 12 is subdivided into a number of individual active material channels 14 that run the length of the extruded body 16. The number of individual channels 14 are formed by extrusion of chemical precursors or a semi-solid paste of active material which is subsequently heat treated to form walls of a dense, solid electrolyte 18. The monolithic body contains an interconnected network of non-porous, electrochemically conductive walls of solid electrolyte 18 which run the length of the battery housing 12. Each channel 14 is supported along its length by perpendicular walls 18 and protected by the battery housing 12.

The walls of solid electrolyte 18 may be non-porous, thus providing better conductivity when compared to porous separators. The walls of solid electrolyte 18 may be relatively thin. The walls may be about 5 to about 2,500 μm thick. The walls of solid electrolyte 18 may be about 5 to about 100 μm thick. In yet another embodiment, the walls 18 may be about 5 to about 50 μm thick.

The solid state battery 10 of the present disclosure may include a variety of materials. For example, the solid state battery 10 may be a lithium battery. The type of material may be selected according to demands of a specific application. The solid state battery 10 may include materials such as Ag₄RbI₅ for Ag⁺ conduction, various oxide-based electrolytes such as lithium lanthanum zirconium oxide (LLZO), lithium phosporhus oxynitride (LiPON), LATP, LiSICON, etc. and sulfide-based electrolytes such as Li₁₀GeP₂S₁₂, Li₂S—P₂S₅, etc. for Li⁺ conduction, a clay and β-alumina group of compounds (NaAl₁₁O₁₇) for Na⁺ conduction and other mono- and divalent ions.

While solid state batteries usually fall into the low-power density and high-energy density category, the solid state battery of the present disclosure has specific energy density and volumetric energy density of about 232 Wh/kg and about 854 Wh/L respectively, which exceed the U.S. Advanced Battery Consortium, LLC. (USABC)'s cell level target of 750 Wh/L. The specific energy density and the volumetric energy density were calculated using the following data: cell voltage about 3.6 V, height of channel about 30.00 cm, width of cathode channel about 0.04 cm, length of cathode channel about 0.05 cm, volume of cathode channel about 0.06 cm³, cell capacity per channel about 0.025 Ah, total volume of a unit cell about 0.106 cm³, and total weight of unit cell about 0.39 g.

The solid state battery 10 of the present disclosure may have more than one configuration of channel geometries, sizes, and/or ratio of anode to cathode channels to suit material requirements of an individual application. For example, the channels may have cross-section which is substantially regular, irregular, angular, triangular, square, rectangular, circular, oval, shaped substantially like a diamond, tetragon, pentagon, hexagon, heptagon, octagon, nonagon, decagon, hendecagon, dodecagon, tridecagon, tetradecagon, pentadecagon, hexadecagon, heptadecagon, octadecagon, enneadecagon, icosagon, the like, or a combination thereof.

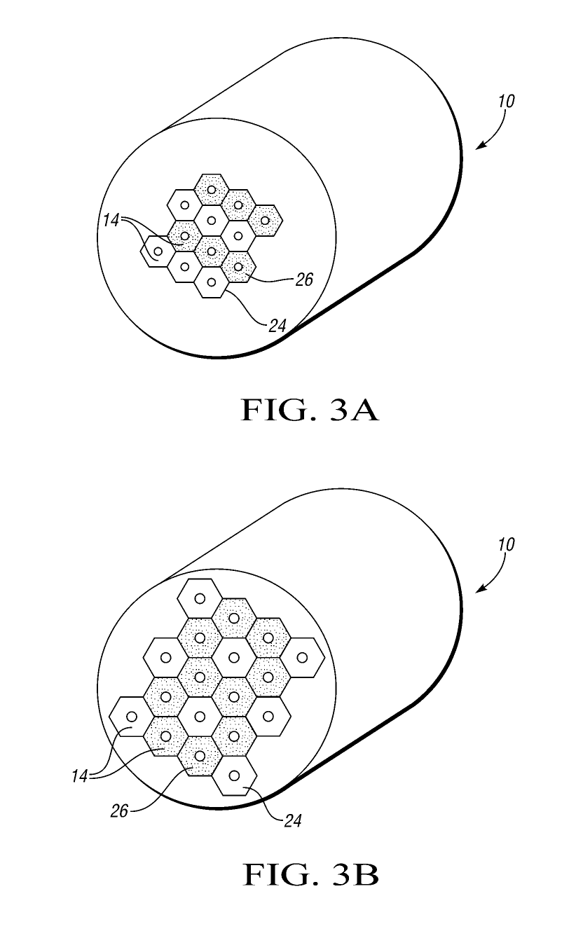

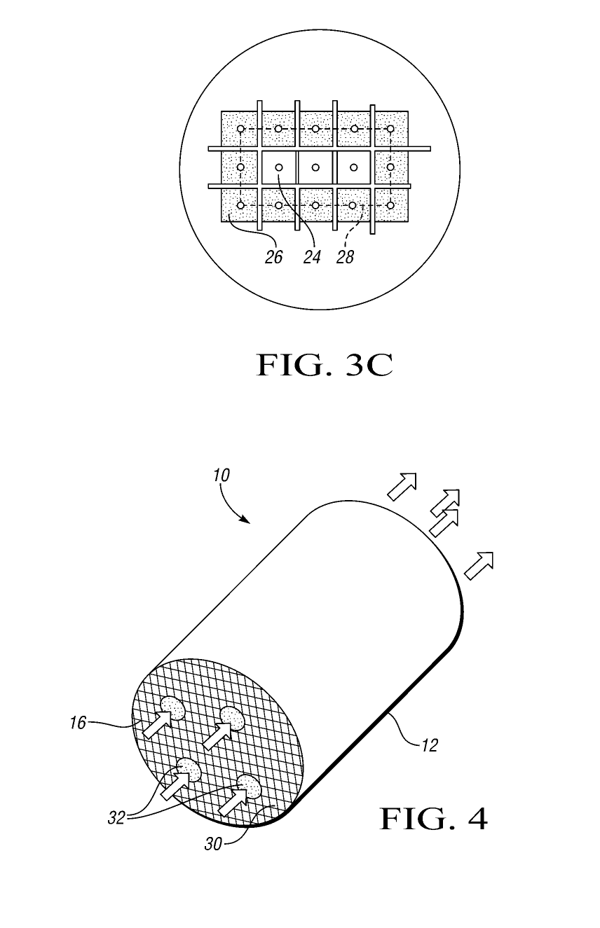

As can be seen in FIG. 2, alternating channels 14 are filled with electrochemically active materials 22 to form positive electrodes 24 and negative electrodes 26 that are separated by a plurality of the non-porous, electrically conductive walls of solid electrolyte 18. The number of positive electrodes 24 may be the same as the number of negative electrodes 26. Alternatively, an unequal number of channels of each active material is contemplated. For example, the number of the plurality of channels in which a cathode material is situated may be greater than the number of the plurality of channels filled with anodic material. Alternatively still, the number of the plurality of channels in which an anodic material is situated may be greater than the number of the plurality of channels filled with a cathode material. FIG. 3A illustrates a solid state battery 10 having an equal number of the plurality of channels having hexagonal cross-section, the channels being filled with positive active material 24 and negative active material 26. FIG. 3B illustrates a solid state battery 10 having an unequal number of positive electrodes 24 and negative electrodes 26, specifically having less channels 14 filled with positive active material 24 than channels 14 filled with negative active material 26.

FIG. 3C illustrates an embodiment in which the number of channels for each active material differs from a ratio of 1:1. Specifically, FIG. 3C illustrates a ratio of channel volumes of 5:3 defined by a unit cell boundary 28. Other ratios are contemplated. Exemplary ratios may be in the range of 1:1 to 100:1. Other exemplary rations may be in the range of 1:1 to 50:1. In at least one embodiment, the exemplary ratios may be in the range of 1:1 to 2:1. The range may depend on the choice of active material(s) and other factors such as material density. Furthermore, different ratios may be advantageous for different combinations of active materials with different volumetric charge capacities.

In some embodiments, the channels 14 may be filled with electrochemically active materials 22 only, as was discussed above. In such embodiments, an additional liquid or polymer electrolyte may be added to support ionic transport. If each channel 14 is sealed at both ends and the inorganic electrolyte monolithic housing 12 has no porosity, different liquid electrolytes may be used for each electrochemically active material 22 to optimize the performance of each electrochemically active material 22. In another embodiment, each channel 14 may be filled with a composite of electrochemically active material 22 and solid electrolyte particles 38.

The solid state battery 10, as depicted in FIG. 4, may include one or more insulating channels 30. The insulating channels 30 may separate channels with active material 14 from one another. For example, the insulating channels 30 may separate an anode from a cathode. An insulating channel 30 may be formed from at least one of the plurality of channels 14. The insulating channels 30 may also separate at least a first series-connected electrochemically active material from at least a second series-connected electrochemically active material.

FIG. 4 also illustrates a number of heating or cooling channels 32. In at least one embodiment, thermal management may be needed to limit heating of the monolithic housing 12, to provide heating to the housing 12 in cold conditions, and/or to assist in achieving and/or maintaining desirable temperature within the channels 14. For example, cooling may be required to counter heat generated within the battery 10, to prevent run-away thermal reactions, and/or to prolong durability of the battery 10 in time.

The heating or cooling channels 32 may run the length of the battery housing 12. The heating or cooling channels 32 may be integrally formed in the battery housing 12 during extrusion of the housing 12. A subset of channels 14 may be used as the heating or cooling channels 32 to conduct a fluid through the housing 12. In some embodiments, the heating or cooling channels 32 are arranged in a regular array, while in others, the heating or cooling channels 32 may be distributed non-uniformly to optimize cooling or heating to the core of the housing 12.

The heating or cooling channels 32 may have cross-section of any shape. For example, the heating or cooling channels 32 may have circular, rectangular, or square-shaped crops-section. Additional exemplary shapes such as those named above are contemplated. The solid state battery 10 may include one or more relatively large heating or cooling channels and/or a higher amount of relatively small heating or cooling channels compared to the size of the channels 14. For example, the heating or cooling channels may have a diameter of about 1.5 times larger, about 2 times larger, about 5 times larger, about 10 times larger or more than the channels 14. In at least one embodiment, the heating of cooling channels are the same size as the channels 14. In another embodiment, the heating or cooling channels are about 1.5 times smaller, about 2 times smaller, about 5 times smaller, about 10 times smaller or more than the channels 14. The solid state battery 10 may include heating and cooling channels 32 of various configurations and sizes.

The insulating channels 30 and/or heating or cooling channels 32 may be filled with a medium such as air. Alternatively, the channels 30, 32 may be filled with a fluid, a mixture of gasses and/or liquids, solid particles, the like, or a combination thereof.

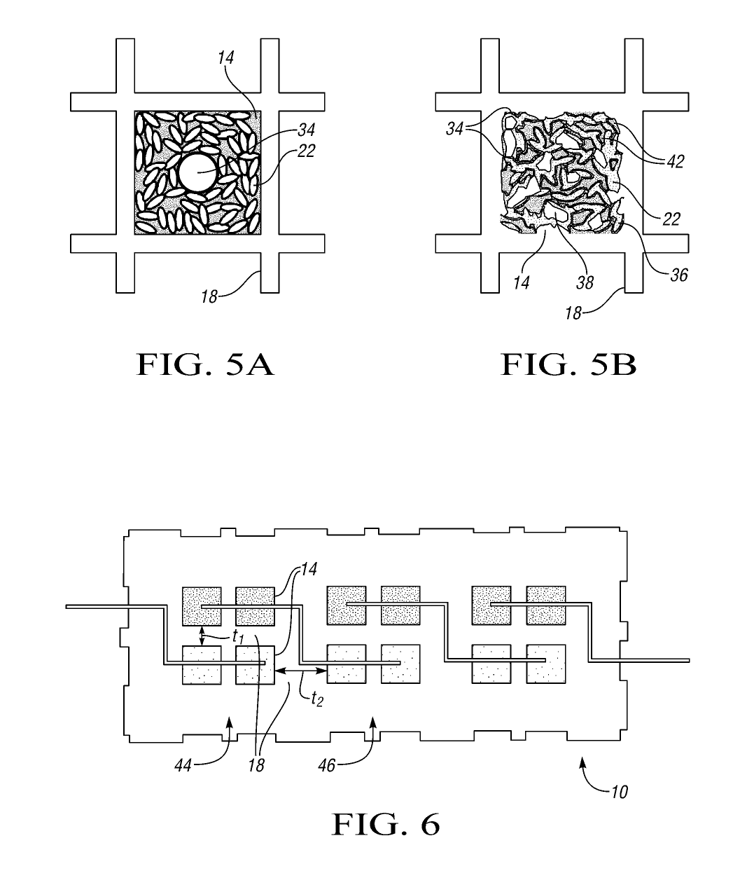

In one or more embodiments, each cell is provided with a conductive element 34 to provide electronic current collection. In each case, the conductive element 34 should be sized to efficiently collect current with low ohmic overpotential based on the volume of the active materials in each channel 14 and the power requirements. The conductive element 34 may provide mechanical support, but is not required to provide mechanical support. The conductive element 34 may be a thin wire, as is illustrated in FIG. 5A. As FIG. 5A further illustrates, the individual wire may be provided in the center of each channel 14. The conductive element 34 may be surrounded by active material 22 in the channel 14. Alternatively, the conductive element 34 may be a conformal deposition of a conductive material onto the interior surfaces of the channel 14. In one or more embodiments, a coating of the conductive element 34 is deposited onto the interior surfaces of the channels 14 by electroless deposition, by coating with a mixture of conductive material such as a metallic paint, or by any other suitable method. In yet another embodiment, the conductive element 34 is applied as a thin foil. Depending on the channel geometry, the current collector 34 for each channel 14 may be realized using a different approach.

Random pore structure within a channel 14 filled with active material 22 may lead to poor electronic conduction between the active material 22 and wire 34 and poor ionic conductivity between the active material 22 and the walls 18. Therefore, in at least one embodiment, depicted in FIG. 5B, the channel 14 may include a sintered mixture 36 of solid electrolyte particles 38 and cathode or anodic active material 22. The sintered mixture 36 helps to achieve good densification and contact between the active material 22 and the walls 18. The channels 14 comprising the sintered mixture 36 include a plurality of pores 42 distributed throughout the sintered mixture 36. One or more surfaces of the pores 42 may be coated with a conductive element 34 to create a current collector in situ. Such a distribution of the conductive element 34 throughout the sintered mixture 36 ensures high ionic conductivity between the solid electrolyte particles 38 and the walls of solid electrolyte 18. Especially desirable electronic conduction between the active material 22 and the conductive element 34 may be achieved by applying a conformal layer of the conductive element 34 within the pores 42. The term “conformal layer” refers to a layer of the conductive material conforming to the true shape of the internal surfaces of the pores 42. The conformal layer may be applied by any suitable technique, for example by electroless deposition, chemical vapor deposition, or application of melted metal resulting in the conductive element 34 at least partially coating and/or filling the pores 42 within the channels 14.

The conductive element 34 may be any material that allows the flow of electrical current in one or more directions. The conductive element 34 may be a metal current collector such as copper, aluminum, silver, the like, or a combination thereof. The conductive element 34 may be non-metal such as graphite or a conductive polymer.

The conductive element 34 may be arranged in such a way that electrical contact between the conductive elements 34 for each channel 14 and current buses is provided on opposite faces of the housing 12 or on the same face of the housing 12. In certain embodiments, the individual conductive elements 34 are first combined into subsets and the subsets are combined to form a bus for the entire housing 12.

In one or more embodiments, the individual channels 18 are electrically connected in parallel, while in other embodiments, the channels 18 are connected in series or in a combination of both to achieve an optimal combination of voltage and current for each housing 12 as a sub-element of a larger battery pack. In the case of series connections, individual pairs of channels or other subsets of the channels 14 may be isolated ionically from adjacent channels 14. In one or more embodiments, the solid state battery 10 includes at least two sets of channels 14 connected parallel or in series within the same housing 12. Different amount of voltage can be achieved. For example a solid state battery 10 with a relatively high voltage may be produced by connecting channels 14 in series. The achieved voltage of the channels 14 connected in series may be about 100 V or more, about 200 V or more, about 300 V or more, or about 400 V or more.

FIG. 6 illustrates that a solid state battery 10 may include at least a first series-connected channels filled with electrochemically active materials 44 and a second series-connected channels filled with electrochemically active materials 46. Connection of additional series is contemplated. To ensure that sufficient ionic resistance between adjacent regions exists, the at least first series 44 may be isolated from the at least second series 46. In one embodiment, this isolation could be achieved by using increased wall thickness to isolate the first series 44 from the second series 46 while maintaining thin walls between the channels 14 of each series. While each channel 14 within a series is separated from adjacent channels 14 by at least one wall 18 having a thickness t₁, each series is separated from adjacent series by at least one wall 18 having a thickness t₂, and t₂ is bigger than t₁·t₁ may be in the range of about 5 to about 2,500 μm. t₂ may be in the range of about 50 to about 25,000 μm. Alternatively, each series of channels 14 may be separated from an adjacent series by one or more insulating channels 30 formed from at least one of the plurality of channels 14. Alternatively still, each series of channels may be separated from an adjacent series by one or more heating or cooling channels 32.

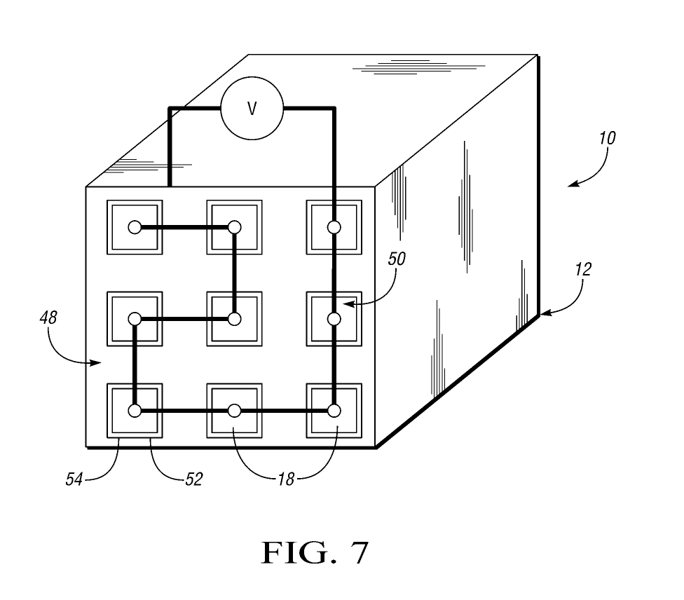

In at least one embodiment depicted in FIG. 7, the solid state battery 10 includes an extruded monolithic housing 12 from a first electrochemically active material 48. The first electrochemically active material 48 may be cathode or anode. The first electrochemically active material 48 forms a plurality of channels 14. Each channel 14 includes a plurality of surfaces 52. The housing 12 is sintered and an electrolyte separator 54 is coated onto the plurality of surfaces 52 as a thin layer of solid electrolyte. The channels 14 are subsequently filled with an opposite electrochemically active material 50. The layer of the electrolyte separator 54 may be about 0.05 to about 100 μm thick. In at least one embodiment, the layer of the electrolyte separator 54 may be about 5 to about 2,500 μm thick. The layer of the electrolyte separator 54 may be applied as a conformal coating. The electrolyte separator 54 separates the extruded, interconnected network of the first active material 48 from the second active material 50.

To further increase power density, the monolith may be formed from a ceramic anode. The sintered ceramic has a relatively rough uneven surface having significant porosity. The porous ceramic may be coated with continuous electrolyte material and any cracks and crevices resulting from the porosity may be filled with a cathode material. Such an embodiment results in increased inter facial area between the two electrodes, which has positive impact on power density of the solid state battery 10.

The present disclosure further provides a method of forming the solid state battery 10. The solid state battery of the present disclosure may be formed by extrusion. The solid state battery may be formed by another suitable method which provides a housing including an interconnected network of non-porous, electrochemically conductive walls forming a plurality of channels. The solid state battery may be formed by extrusion as extrusion enables formation of the housing of the solid state battery including a variety of customizable features which may be built-in to the extrusion profile. The features may include one or more insulating channels, one or more heating or cooling channels, different thickness of walls between the channels and/or a series of channels, or a combination thereof.

The method may further include filling the plurality of channels with electrochemically active material. The method may include a step of filling an equal or unequal amount of channels with material forming a positive electrode and a material forming a negative electrode. The method may include a step of forming a solid state battery having a ratio of channel volumes 1:1 or different than 1:1. Exemplary ratios may be from 1:1 to 10:1. In at least one embodiment, the ratios may be from 1:1 to 5:1.

The method may include filling some of the channels with an insulating material such as a non-conducting fluid or particles. The method may further include filling the heating or cooling channels with a heating or a cooling medium.

The method may include a step of supplying a conductive element to the channels. The conductive element may be applied by a variety of techniques such as inserting a wire within a channel or within an active material located within the channel, applying metal foil to at least one surface within the channel, depositing metal paint on at least one surface within the channel, or any other suitable method.

In at least one embodiment, the method includes steps of mixing an electrochemically active material with solid electrolyte particles, sintering the mixture of the active material and solid electrolyte to gain a sintered mixture, and filling a channel with the sintered mixture. The method may also include a step of creating a plurality of pores within the sintered mixture. The method may include a further step of supplying a conductive element within the channel to provide a distributed current collector. This can be done by a variety of techniques non-limiting examples of which are applying a conductive paint, utilizing sol-gel method, chemical vapor deposition, a liquid process, melting a metal and allowing the metal to infiltrate the pores. The method may also include a step of applying the conductive element as a conformal layer to the surfaces of the pores within the channel.

The method may further include a step of forming at least a first series-connected electrochemically active materials situated within at least a first number of plurality of channels and at least a second series-connected electrochemically active materials situated within at least a second number of plurality of channels. The method may further include separating the first series from the second series by dividing the first series from the second series by a wall with an increased thickness compared to the thickness of the walls separating individual channels within each series. The method may include a step of separating the first series from at least the second series by at least one insulating or heating or cooling channel.

The method may include a step of extruding a monolith housing from an electrochemically active material—cathode or anode. The method may further include a step of sintering the monolith forming a plurality of channels. The method further includes a step of applying electrolyte to a plurality of surfaces within the channels. The method may include a step of applying the electrolyte as a conformal coating. The method may further include a step of filling the channels with the opposite active material.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A solid state battery comprising:
an extruded, interconnected network of a first electrochemically active material forming a plurality of channels;
an electrolyte coated onto surfaces of each of the plurality of channels and forming a plurality of coated channels; and
a second electrochemically active material situated within each coated channel.

2. The battery of claim 1, wherein the first electrochemically active material is one of a cathode or anode and the second electrochemically active material is the other of a cathode or anode.

3. The battery of claim 1, wherein the electrolyte separates the extruded, interconnected network from the second electrochemically active material.

4. The battery of claim 1, wherein a thickness of the electrolyte in at least one of the coated channels is in a range of about 50 nm to about 100 μm (t_{E}).

5. The battery of claim 1, wherein the electrolyte is a solid electrolyte.

6. The battery of claim 1, wherein the electrolyte is coated onto surfaces of the channels as a conformal coating.

7. The battery of claim 1, wherein the second electrochemically active material is electrically connected.

8. The battery of claim 1, wherein each coated channel further includes a plurality of solid electrolyte particles, the solid electrolyte particles and the second electrochemically active material being mixed and sintered together to form a sintered mixture, and wherein the sintered mixture comprises a plurality of pores including a conductive metal.

9. The battery of claim 8, wherein the conductive metal forms a conformal coating.

10. The battery of claim 8, wherein the plurality of pores including the conductive metal are distributed throughout the sintered mixture.

11. The battery of claim 8, wherein the conductive metal is a current collector.

12. The battery of claim 8, wherein the conductive metal runs the length of the battery housing.

13. The battery of claim 8, wherein the battery is a lithium battery.

14. A solid state battery comprising:
a battery housing;
an extruded, interconnected network of non-porous, electrochemically conductive walls forming a solid electrolyte within the battery housing;
a plurality of channels formed by the extruded, interconnected network;
a cathode situated within a first number of the plurality of channels; and
an anode situated within a second number of the plurality of channels.

15. The battery of claim 14, wherein the cathode and anode are separated by at least one of the non-porous, ionically conductive walls.

16. The battery of claim 14, wherein a thickness of the non-porous, electrochemically conductive walls is in a range of about 5 to about 2,500 μm (t_{w}).

17. The battery of claim 14, wherein the cathode and anode are separated by at least one insulating channel formed from at least one of the plurality of channels.

18. The battery of claim 14, wherein the first number is equal or not equal to the second number.

19. The battery of claim 14, wherein the plurality of channels includes one or more heating or cooling channels.

20. The battery of claim 14, wherein the extruded, interconnected network of non-porous, electrochemically conductive walls runs the length of the battery housing.

21. A solid state battery comprising:
a battery housing;
an extruded, interconnected network of non-porous, ionically conductive walls forming a solid electrolyte and a plurality of channels within the battery housing;
an anode or cathode situated within the plurality of channels including a sintered mixture of solid electrolyte particles and an electrochemically active material, the sintered mixture including a plurality of pores; and
a conductive metal situated in the plurality of pores.

22. The battery of claim 21, wherein the conductive metal forms a conformal coating.

23. The battery of claim 21, wherein the plurality of pores including the conductive metal are distributed throughout the sintered mixture.

24. The battery of claim 21, wherein the conductive metal is a current collector.

25. The battery of claim 21, wherein the conductive metal runs the length of the battery housing.

26. The battery of claim 21, wherein the battery is a lithium battery.

27. A solid state battery comprising:
a housing;
an extruded, interconnected network of non-porous, electrochemically conductive walls forming a solid electrolyte within the housing;
a plurality of channels formed by the extruded, interconnected network; and
at least first and second series-connected electrochemically active materials situated within at least a first and second number of the plurality of channels.

28. The solid battery of claim 14, wherein each channel within the series is separated by a wall of t₁, each series separated by a wall of t₂, and t₂>t₁.

29. The solid battery of claim 28, wherein t₁ is in a range of about 5 to about 2,500 μm.

30. The solid battery of claim 28, wherein t₂ is in a range of about 50 to about 25,000 μm

31. The solid battery of claim 27, wherein each series is separated by at least one insulating channel formed from at least one of the plurality of channels.

32. The solid battery of claim 27, wherein each series is separated by at least one heating or cooling channel.

33. The solid battery of claim 27, wherein the battery is a lithium battery.
